(19) United States
(12) Patent Application Publication
(10) Pub. No.: US 2003/0112118 A1
(43) Pub. Date: Jun. 19, 2003

(54) Electronic high-security safe lock

(76) Inventor: Ahmed Raslan, Brooklyn, NY (US)

Correspondence Address: Slater & Cole, LLP, Suite 1101, 11 Broadway, New York, NY, 10004, US

(21) Appl. No.: 10/025,226

(22) Filed: Dec. 18, 2001

(51) Int. Cl. G06F 7/04

(52) U.S. Cl. 340/5.2; 340/5.7; 361/172

(57) ABSTRACT

An electronic lock system for large armored safe movable entry barrier locks that records all access attempts and limits access to persons having two credentials, an access code recorded on an access card as well as a numerical personal identification code (PIN). The access barrier of the system comprises a solenoid-controlled dead bolt whose position changes when a 3V pulse from a microprocessor is passed through a voltage step-up relay that uses 120 V AC input passed through an AC to DC converter to increase the voltage to a 15V pulse capable of causing the solenoid to move the dead bolt barrier. In using the system, the access-seeking individual presents the required access card and inputs a Personal Identification Number (PIN). The access code recorded on the card and the inputted PIN are checked against a ROM-stored authorization codes to determine whether there is or is not a match. No match results in denial of access and termination of the program; a match results in a grant of access along with a display prompt that directs the access seeker to indicate whether the dead bolt solenoid is to be opened or closed.

### BACKGROUND OF THE INVENTION

Banks and certain business establishments have a need for very secure safes. In these circumstances a high security safe may be appropriately accessed by more than one person. Often, repeated access by a number of trusted employees and officers of the institution is required for efficient conduct of the business.

Large high security safe installations are typically set within thick hardened steel vault enclosures that include massive or roller-mounted steel doors. These massive doors often require considerable force to open or close and accordingly, where electrically driven, require significant electrical power to actuate. The lock bolts on deadbolts in the larger safes are massive and require significant power to move. Whatever the large safe vault design, substantial power is required to unlock and open and to close and lock.

Traditionally, safes were unlocked or prepared for access by operation of a mechanical combination lock. The combination for access to the safe was set by a qualified locksmith. Each person with authorized access to the safe would be furnished with the safe lock combination. The authorized person would then commit the operable lock combination to memory for later use.

In the event one of the authorized access persons left employment in the institution, or the access combination was believed compromised, the access combination had to be changed by a locksmith and all authorized persons were required to learn and memorize a new combination.

It is convenient to have a record identifying which authorized person entered the safe and the time of his or her entry. The mechanical combination lock with shared multi person access makes it difficult to create or maintain accurate records of access events.

The appearance of secure electronic locks is a relatively recent development. Many electronic locks have been described in the patent literature, each of these earlier lock systems have been devised to provide one or more improved features such as recording each access event or, for example, providing less expensive change in the access code. However, none of these earlier electronic lock systems have been applicable to the unique set of high security yet convenient multiple person authorized access desired in larger high security safe vault installations.

### SUMMARY OF THE INVENTION

The invention is comprised of multistage means for identifying and determining the authorization of a person attempting to enter a large safe entry barrier. The multiple stages include an access card means furnished each authorized person, access card reader and keypad digital signal input means. A first microprocessor, the access card signal being entered into the first microprocessor. A control microprocessor, the keypad digital signal being entered into the control microprocessor. The first and control microprocessors having Read Only Memories (ROM) into which authorized identification codes are entered upon which identification codes may be matched or, if not matched, the access will be denied. Solenoid operated dead bolt locks are mounted upon the safe entry barrier. A source of high voltage DC electric power, electrical switch means for energizing the deadbolt solenoid to alternately assume an open position or a closed position by connecting the higher voltage DC electrical power source through the switch. The digital signal input derived from the control microprocessor provides information to control the switch means, whereby a massive safe solenoid lock may be operated while maintaining high security protocol.

### OBJECTS OF THE INVENTION

A first object of the present invention is to provide a highly secure electronic lock system having sufficient power adapted to unlocking and opening or securely locking a safe vault door having movable dead lock bolts.

Another object of my invention is to provide an electronic system for secure authorized multi-person user access to a safe installation.

Another object of my invention is to provide an electronic system utilizing both an access card and a numerical Personal Identification Number wherein the secure lock system actuates using sufficient augmented electric power a solenoid-controlled deadbolt access control barrier to a safe installation.

Still another object of my invention is to provide an electronic secure lock system which provides inexpensive and readily executed changes in access codes for one or more of several authorized persons wherein such access code changes require no extensive mechanical safe lock adjustments.

Yet another object of my invention is to provide an electronic safe lock system for authorized access having means to provide sufficient electric power for large safe installations wherein the identity of the person and time of his or her authorized access is unambiguously recorded.

Other objects and advantages of the invention will be apparent from the following illustrations, specification, and claims.

### BRIEF DESCRIPTION OF THE DRAWINGS

FIG. 1 is a diagram showing the component parts of a preferred embodiment of my invention.

FIG. 2 is a flow chart showing the flow of information during operation of the preferred embodiment of my invention illustrated in FIG. 1.

FIG. 3 illustrates a variation of the preferred embodiment shown in FIG. 1.

### DETAILED DESCRIPTION OF THE PREFERRED EMBODIMENT

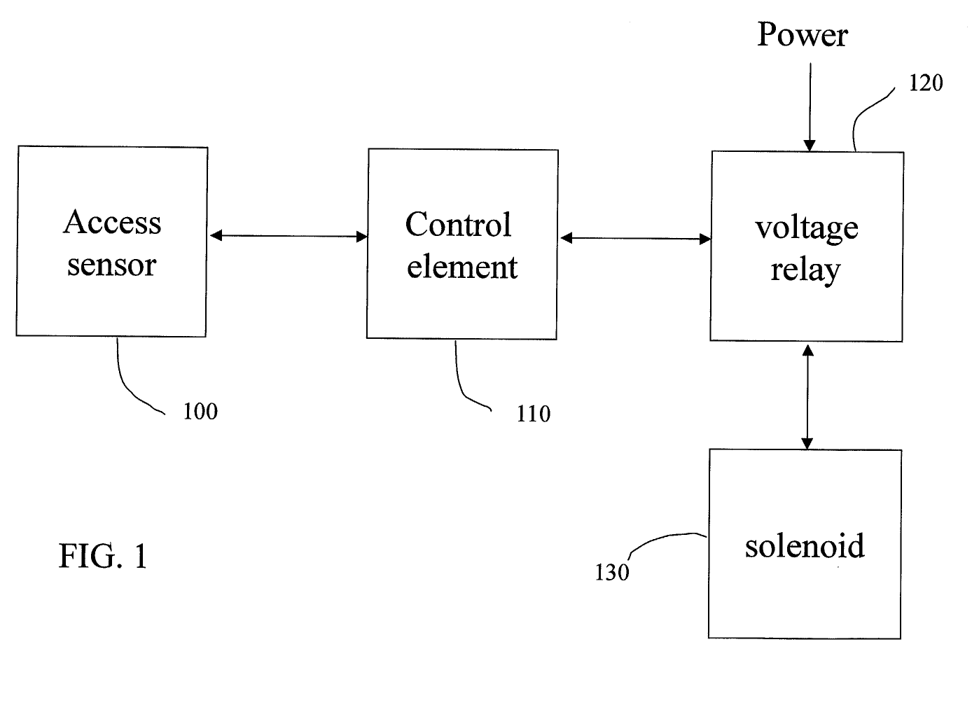

Referring to FIG. 1, which shows a schematic block diagram of a preferred embodiment of the invention, code sensor 200 is adapted to read numerical data encoded on the magnetic strip of a plastic access card. When a such an access card is swiped through the reader of code sensor 200, numerical data are transmitted to first microprocessor 210 which has a read-only memory (ROM), in which are contained allow access codes. If no match between the transmitted data and an access code is found, the program terminates and the display reads “access denied”, while a match results in a display prompt reading “enter PIN”. When a PIN is entered by means of a keypad 220, the entered data is transmitted to a control microprocessor 230 having a read-only memory (ROM) that compares the inputted PIN to a list of allowed PINS. NO match results in termination of the program and a display prompt reading “access denied”, while a match results in a display prompt such as “enter instruction code that requests a numerical code that will specific one or two electronic messages that result in sending a signal in the form of a 3 V pulse that passes through a voltage step up relay 240, into which 120 V AC flows after passing through an AC to DC converter, and then to either the deadbolt open solenoid 260 or the deadbolt close solenoid 270 that together control the deadbolt entry barrier. A 15 V DC battery 250 operates as a standby source of power in the event it is needed to actuate the solenoid should the AC source fail.

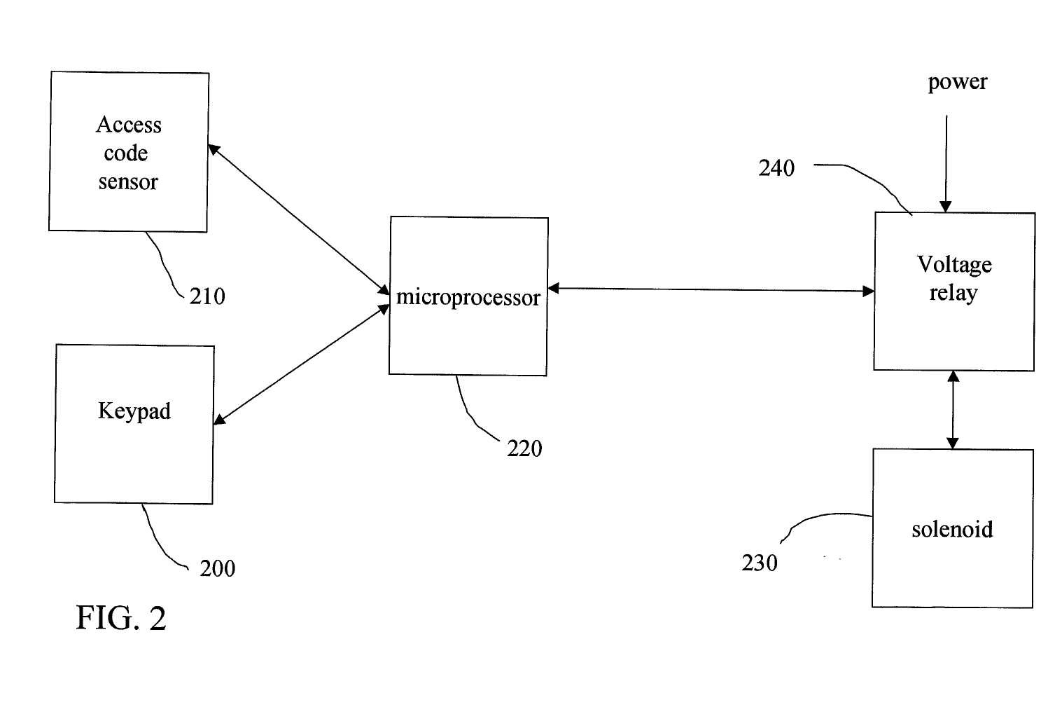

Referring now to FIG. 2, which shows the flow of information during operation of the preferred embodiment, access code sensor 200 reads data contained on an access card and transmits it to first microprocessor 210, where it is compared to allow codes stored in the ROM. A match prompts the user to enter a numerical PIN using keypad 220. The inputted PIN is transmitted to a control microprocessor 230 which records the inputted PIN and the time of the attempted entry and compares the inputted PIN to a list of ROM-stored allowed access PINs to determine whether a match exists. If a match exists, the display prompts the access seeker to enter numerical instructions. The input of a numerical instruction code results in a 3V signal being sent from the control microprocessor 230. This 3V signal is then amplified by 120V AC current passing through an AC to DC converter 245 to yield a 15V pulse which then actuates either the open solenoid or the close solenoid depending upon which numerical message had been inputted.

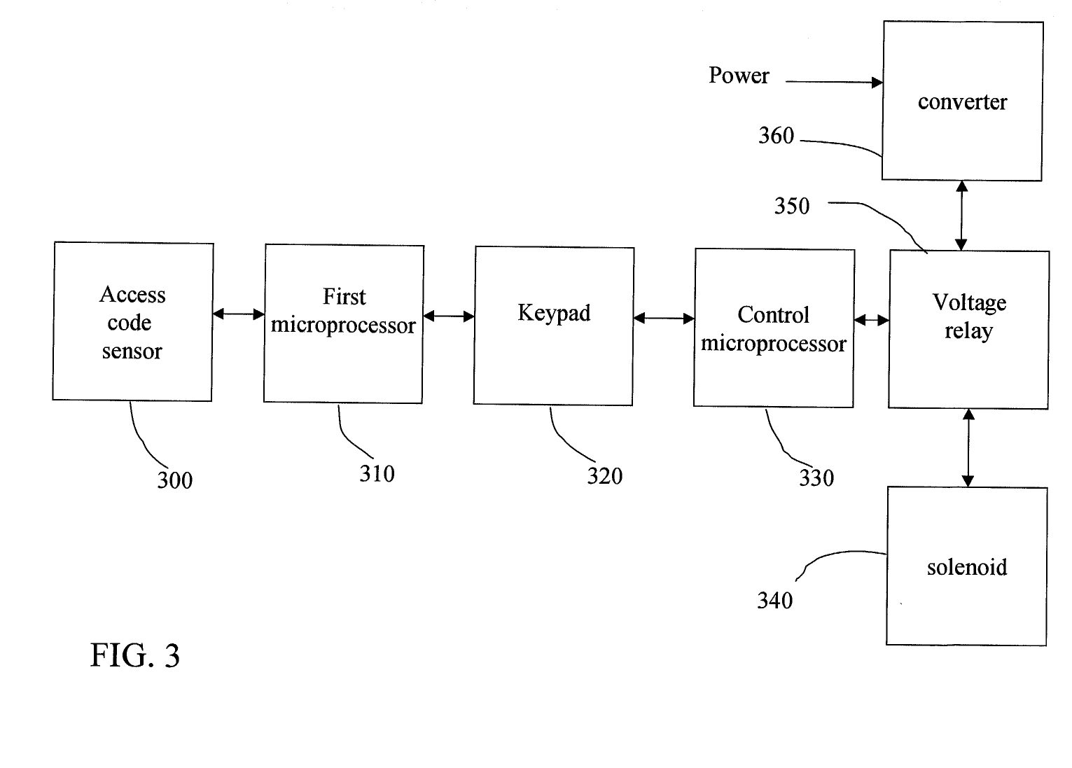

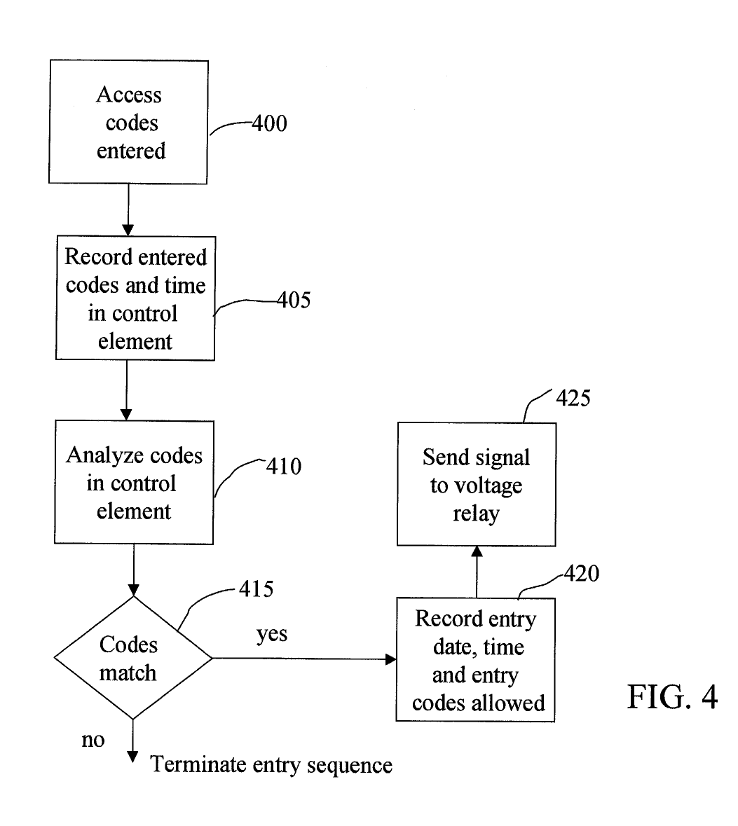

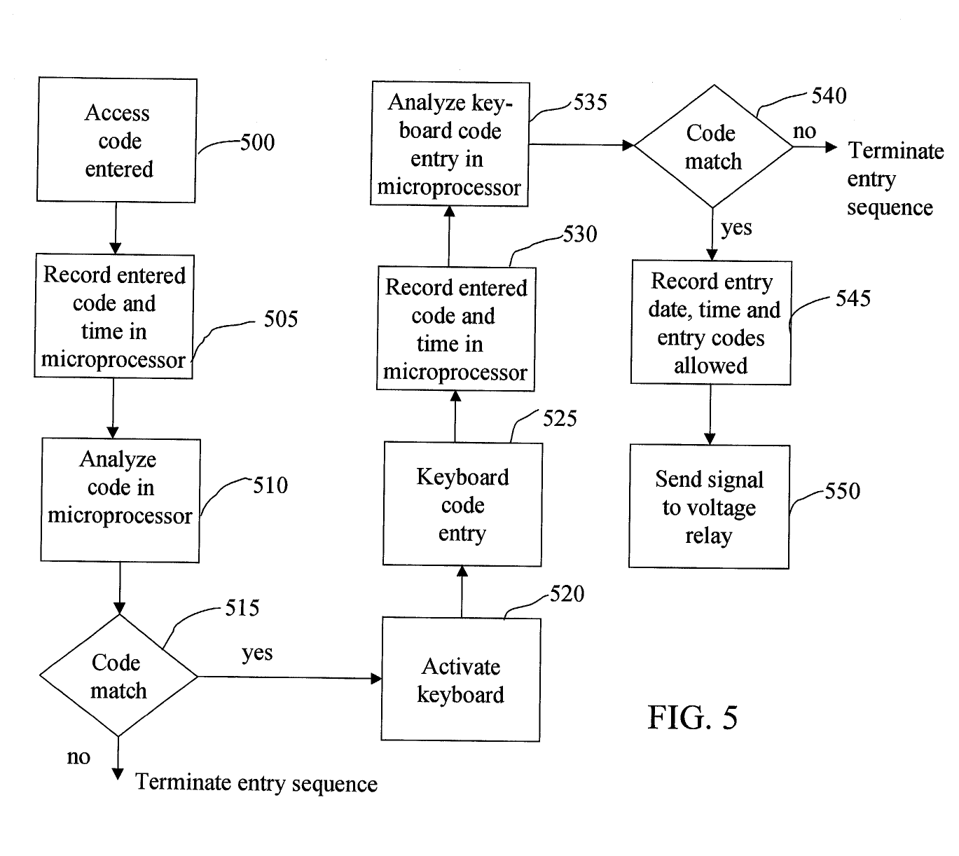

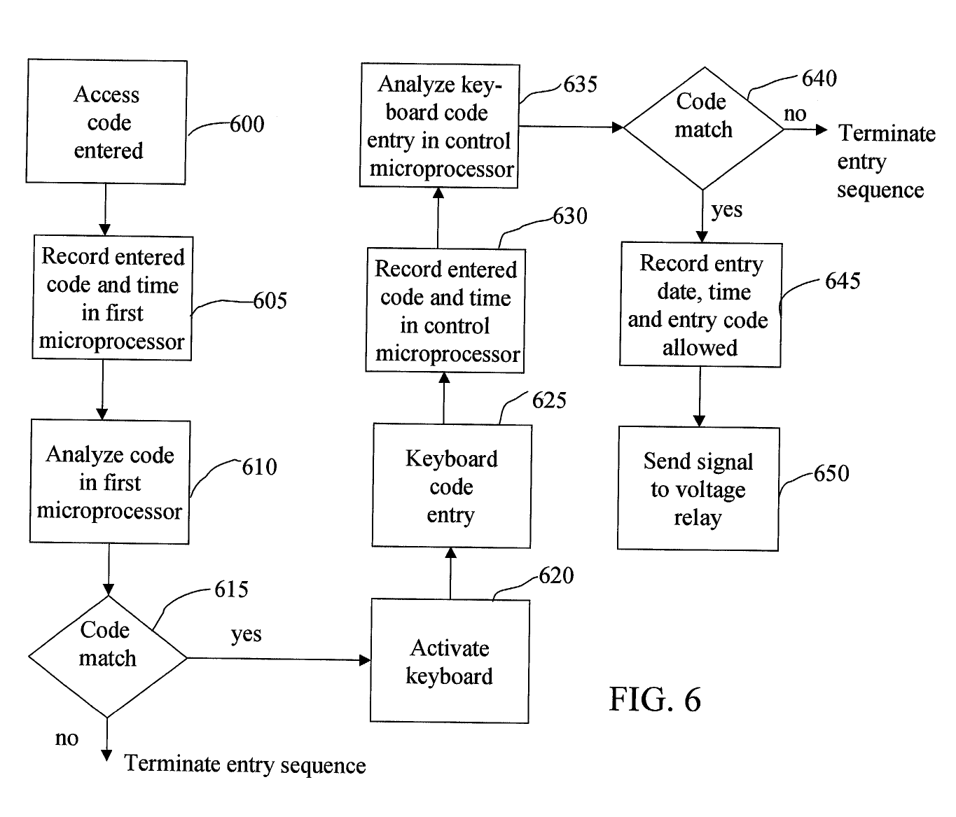

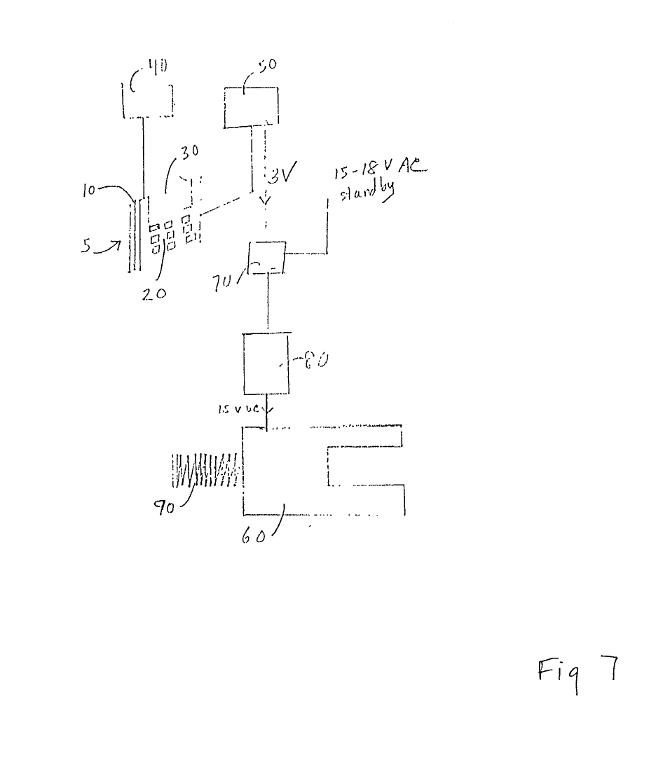

Referring to FIG. 3 which shows a second embodiment of the invention that utilizes a spring loaded solenoid deadbolt access barrier, access card reader 10 and keypad 20 are combined in a wall amount unit 5. Display 30 instructs an access seeker to swipe an access card through access card reader 10. Upon swiping the card, the access code recorded on the card is transmitted to a first microprocessor 40 which compares it a list of ROM-stored access codes. If no match is detected, the program is terminated and the display 30 will read “access denied”. If a match is detected, the display 30 instructs the access seeker to input a numerical PIN using keypad 20. The PIN is transmitted to a control microprocessor 50, having a Read Only Memory (ROM) in which are stored authorized PINs. The inputted PIN is compared to the authorized PINs, and if no match is found, the program is terminated and display 30 will read “access denied.” If a match is found between the inputted PIN and an authorized code, the display 30 will prompt the access seeker to give further instructions, which may include numerical codes for adjusting the time delay of the spring-loaded, solenoid controlled deadbolt barrier 60. A 3 volt pulse is then sent from control microprocessor 50 to voltage step-up relay 70 where it is amplified, perhaps by using an AC standby battery. Voltage step up relay then sends a 15 volt DC current to solenoid 80, which results in opening the deadbolt barrier 60 and compressing a spring 90. The deadbolt barrier 60 stays open until the period of the time delay expires. Following the expiration of the time delay, the spring is 90 released, closing deadbolt access barrier 60.

What is claimed is:

1. An secure electronic lock system for a large armored safe vault movable entry barrier comprised of a system access code sensor, the code input being generated by a person seeking access to the lock system using a tangible means to generate a short coded signal, a first microprocessor, the first microprocessor being programmed to receive the sensor mediated code and compare said code with previously entered coded signals for authorized access to the system, a keypad, coded signals which, when compared, match a previously entered authorized access coded signal generate an enabling entry wherein the keypad will then accept personal identification numerical code and additional numerical coded instruction, a control microprocessor, the control microprocessor having a ROM (read only memory) wherein the authorized personal identification numerical codes are stored, the keypad personal code and instructions are fed into the input of the control microprocessor, whereupon the personal identification code is compared with the authorized access identification codes stored in the ROM, failure to find a match terminates the program, a match progresses the control microprocessor program to sense and interpret the keypad instruction code, whereupon the control microprocessor output provides a 3 V DC pulse, a voltage step-up relay, the relay is connected to the 120V AC power line, an AC to DC converter, the relay and AC to DC converter are connected to provide a 15-18V DC output from the converter, the 3 V DC pulse actuates the converter through switch means to provide a sustained 15-18V DC current, movable lock deadbolt members, the lock deadbolt members are provided with a first open solenoid which retracts the deadbolt to an open position and a second solenoid which advances the deadbolt members to a closed and locked position whereby an electronically operated high security safe lock system is provided with readily altered access authorization for multiple person access into an armored large safe entrance and exit barriers.

2. A secure electronic lock system for a large armored safe movable entry barrier comprised of a system access code sensor, the code input being generated by a person seeking access to the lock system using a tangible means to generate a short coded signal, a first microprocessor, the first microprocessor being programmed to receive the sensor mediated code and compare said code with previously entered coded signals for authorized access to the system, a keypad, coded signals, which, when compared, match a previously entered authorized access coded signal generated and enabling entry wherein the keypad will then accept personal identification numerical code and additional numerical coded instructions, a control microprocessor, the control microprocessor has a ROM (read only memory) wherein authorized personal identification numerical codes are stored, the keypad personal code and instructions are fed into the input of the control microprocessor, whereupon the personal identification code is compared with the authorized access identification codes stored in the ROM, absence of a match terminates the program, existence of a match causes the control microprocessor program to sense and interpret the keypad instruction action code, whereupon the control microprocessor output comprises a 3-volt DC pulse, a voltage step-up relay, the relay is connected to the 120V AC power line, an AC to DC converter, the relay and AC to DC converter are connected to provide a 15-18V DC output from the converter, the 3 volt DC pulse from the control microprocessor actuates the switch means to provide a sustained 15-18 volt DC pulse, movable lock deadbolt members, the deadbolt members being provided with a first open solenoid which retracts the deadbolt to an open position and a second solenoid which advances the deadbolt members to a closed and locked position whereby an electronically operated high security safe lock system is provided with readily altered access authorization for multiple person access into armored large safe entrance and exit barriers.

3. The system of claim 1 in which the entry barrier solenoid is held closed by a spring means, the input of an authorized personal identification number results in a 3V control microprocessor output that actuates the open solenoid dead bolt barrier, a compression of the spring means for holding the dead bolt in a closed position and the spring means being restricted by the action of the solenoid and unlocking of the deadbolt barrier.

4. The system of claim 3 in which the duration of the time delay holding the deadbolt spring in a compressed position may be varied by inputting instructions into the control microprocessor via the keypad.
